(19) United States
(12) Patent Application Publication
(10) Pub. No.: US 2023/0193061 A1
(43) Pub. Date: Jun. 22, 2023

(54) WATER-BASED INK, PRINTED RECORDING MEDIUM, AND INK CARTRIDGE

(71) Applicant: BROTHER KOGYO KABUSHIKI KAISHA, Nagoya (JP)

(72) Inventors: Narumi Yamashita, Kuwana (JP); Nozomi Suzuki, Nisshin (JP); Tomoyo Tahara, Ichinomiya (JP); Ai Sakaguchi, Kaizu (JP); Makito Iguchi, Nagoya (JP); Yuka Tsuzaka, Nagoya (JP)

(73) Assignee: BROTHER KOGYO KABUSHIKI KAISHA, Nagoya (JP)

(21) Appl. No.: 18/146,550

(22) Filed: Dec. 27, 2022

Related U.S. Application Data
(63) Continuation of application No. PCT/JP2021/024106, filed on Jun. 25, 2021.

(30) Foreign Application Priority Data
Jun. 29, 2020 (JP) 2020-111248

(51) Int. Cl. C09D 11/328; C09D 11/033; C09D 11/037; C09D 11/38; B41J 2/175

(52) U.S. Cl. CPC C09D 11/328; C09D 11/033; C09D 11/037; C09D 11/38; B41J 2/17503

(57) ABSTRACT

A water-based ink includes: a dye; water; an acidic preservative; and at least one of a surfactant and a penetrant. The acidic preservative preferably includes at least one selected from the group consisting of a polyvalent unsaturated fatty acid, a polyvalent unsaturated fatty acid salt, dehydroacetic acid, and a dehydroacetate. A content of the acidic preservative in the water-based ink is preferably 0.3% by mass to 6.0% by mass relative to a total mass of the water-based ink. The surfactant preferably includes an acetylene-based surfactant. The penetrant preferably includes at least one selected from the group consisting of an alkylene diol and a glycol ether compound.

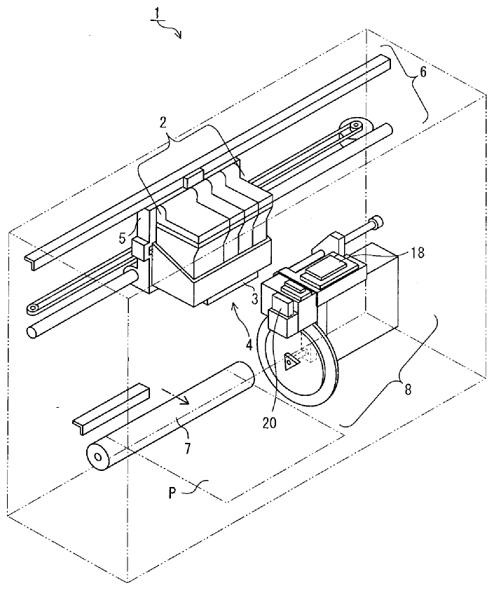

### REFERENCE TO RELATED APPLICATIONS

The present application is a continuation application of International Patent Application of PCT/JP2021/024106, which claims priority to Japanese Patent Application No. 2020-111248, filed on Jun. 29, 2020. The entire disclosures of these applications are incorporated herein by reference.

### BACKGROUND ART

A method that increases coloring agent density is known as a method for improving the optical density (OD value) of a recorded matter made using a water-based ink.

However, when the coloring agent density is increased, cost often increases, and the stability of the water-based ink is often reduced.

### SUMMARY

According to an aspect of the present disclosure, a water-based ink includes a dye; water; an acidic preservative; and at least one of a surfactant and a penetrant.

According to another aspect of the present disclosure, a printed recording medium includes a recording medium and the above-described water-based ink, printed on the recording medium.

According to a further aspect of the present disclosure, an ink cartridge includes the above-described water-based ink stored therein.

### BRIEF DESCRIPTION OF THE DRAWING(S)

A more complete appreciation of the disclosure and many of the attendant advantages thereof will be readily obtained as the same becomes better understood by reference to the following detailed description when considered in connection with the accompanying drawings, wherein the FIGURE is a schematic perspective view illustrating a configuration of one example of the inkjet recording device of the present disclosure.

### DESCRIPTION

As used herein, the words “a” and “an” and the like carry the meaning of “one or more.” When an amount, concentration, or other value or parameter is given as a range, and/or its description includes a list of upper and lower values, this is to be understood as specifically disclosing all integers and fractions within the given range, and all ranges formed from any pair of any upper and lower values, regardless of whether subranges are separately disclosed. Where a range of numerical values is recited herein, unless otherwise stated, the range is intended to include the endpoints thereof, as well as all integers and fractions within the range. As an example, a stated range of 1-10 fully describes and includes the independent subrange 3.4-7.2 as does the following list of values: 1, 4, 6, 10.

Exemplary embodiments of water-based according to the present disclosure (hereinafter referred to as “water-based ink” or “ink”) will be described. The water-based ink of the present disclosure includes a dye, water, an acidic preservative, and at least one of a surfactant and a penetrant.

The water-based ink for inkjet recording of the present disclosure can improve the optical density (OD value) of a recorded matter made using a water-based ink without increasing the coloring agent density and can impart preservative properties, by including the acidic preservative in the formulation. The water-based ink for inkjet recording of the present disclosure is also improved in color saturation by including the acidic preservative in the formulation.

In the present disclosure, saturation (C*) is calculated by the following formula from a* and b* based on the L*a*b* color system (CIE1976 (L*a*b*) color system) standard made by the International Commission on Illumination (CIE) in 1976 (see JIS Z 8729).

C*={(a*2)+(b*2)}½

The dye is not particularly limited, and examples include direct dyes, acidic dyes, basic dyes, reactive dyes, and the like. Specific examples of the dye include C.I. Direct Black, C.I. Direct Blue, C.I. Direct Red, C.I. Direct Yellow, C.I. Direct Orange, C.I. Direct Violet, C.I. Direct Brown, C.I. Direct Green, C.I. Acid Black, C.I. Acid Blue, C.I. Acid Red, C.I. Acid Yellow, C.I. Acid Orange, C.I. Acid Violet, C.I. Basic Black, C.I. Basic Blue, C.I. Basic Red, C.I. Basic Violet, C.I. Food Black, and the like. Examples of the C.I. Direct Black include C.I. Direct Black 17, 19, 32, 51, 71, 108, 146, 154, 168, and the like. Examples of the C.I. Direct Blue include C.I. Direct Blue 6, 22, 25, 71, 86, 90, 106, 199, and the like. Examples of the C.I. Direct Red include C.I. Direct Red 1, 4, 17, 28, 83, 227, and the like. Examples of the C.I. Direct Yellow include C.I. Direct Yellow 12, 24, 26, 86, 98, 132, 142, 173, and the like. Examples of the C.I. Direct Orange include C.I. Direct Orange 34, 39, 44, 46, 60, and the like. Examples of the C.I. Direct Violet include C.I. Direct Violet 47, 48, and the like. Examples of the C.I. Direct Brown include C.I. Direct Brown 109 and the like. Examples of the C.I. Direct Green include C.I. Direct Green 59 and the like. Examples of the C.I. Acid Black Include C.I. Acid Black 2, 7, 24, 26, 31, 52, 63, 112, 118, and the like. Examples of the C.I. Acid Blue include C.I. Acid Blue 9, 22, 40, 59, 90, 93, 102, 104, 117, 120, 167, 229, 234 and the like. Examples of the C.I. Acid Red include C.I. Acid Red 1, 6, 32, 37, 51, 52, 80, 85, 87, 92, 94, 115, 180, 256, 289, 315, 317, and the like. Examples of the C.I. Acid Yellow include C.I. Acid Yellow 11, 17, 23, 25, 29, 42, 61, 71, and the like. Examples of the C.I. Acid Orange include C.I. Acid Orange 7, 19, and the like. Examples of the C.I. Acid Violet include C.I. Acid Violet 49 and the like. Examples of the C.I. Basic Black include C.I. Basic Black 2 and the like. Examples of the C.I. Basic Blue include C.I. Basic Blue 1, 3, 5, 7, 9, 24, 25, 26, 28, 29, and the like. Examples of the C.I. Basic Red include C.I. Basic Red 1, 2, 9, 12, 13, 14, 37, and the like. Examples of the C.I. Basic Violet include C.I. Basic Violet 7, 14, 27, and the like. Examples of the C.I. Food Black include C.I. Food Black 1, 2, and the like.

The formulation amount of the dye with respect to the total amount of water-based ink is, for example, 0.1 to 20% by weight, preferably 0.3 to 10% by weight.

One type of the dye may be used alone, or two or more types may be used in combination.

The water is preferably de-ionized water or pure water. The amount of formulation amount of water (water ratio) with respect to the total amount of the water-based ink is appropriately determined according to desired ink characteristics and the like. The water ratio may be, for example, the remainder after other components.

As described above, the water-based ink of the present disclosure further includes an acidic preservative.

The acidic preservative preferably includes at least one of a polyvalent unsaturated fatty acid, a polyvalent unsaturated fatty acid salt, dehydroacetic acid, and a dehydroacetate. The polyvalent unsaturated fatty acid is preferably sorbic acid, and the polyvalent unsaturated fatty acid salt is preferably a sorbate. The sorbate preferably includes at least one of potassium sorbate and sodium sorbate. The dehydroacetate is preferably sodium dehydroacetate.

The acidic preservative may include another preservative (hereinafter referred to as “other preservative”) in addition to or instead of at the least one of a polyvalent unsaturated fatty acid, a polyvalent unsaturated fatty acid salt, dehydroacetic acid, and a dehydroacetate. Examples of the other preservatives include salicylic acid, benzoic acid, benzoate, and the like.

One type of the acidic preservative may be used alone, or two or more types may be used in combination.

The formulation amount of the acidic preservative with respect to the total amount of water-based ink is not particularly limited and is, for example, 0.1 to 10% by weight, preferably 0.1 to 6% by weight, and more preferably 0.3 to 6.0% by weight. Furthermore, when the acidic preservative is at least one of dehydroacetic acid and a dehydroacetate, the formulation amount of the acidic preservative with respect to the total amount of water-based ink is, for example, 0.1 to 10% by weight, preferably 0.3 to 6% by weight, and more preferably 1.0 to 5.0% by weight.

As described above, the water-based ink of the present disclosure, by including the acidic preservative in the formulation, can improve the optical density (OD value) and saturation of a recorded matter made using a water-based ink without increasing the coloring agent density, and can impart preservative properties. The mechanism for improving the optical density (OD value) by adding the acidic preservative is, for example, presumed to be the following. When the acidic preservative is a polyvalent unsaturated fatty acid and/or a salt thereof, the polyvalent unsaturated fatty acid and/or the salt thereof has a lower molecular weight than the dye, and therefore is believed to penetrate the fibers of the recording medium prior to the dye. The polyvalent unsaturated fatty acid and/or the salt thereof has many carbon (C) double bonds (unsaturated bonds), and thus the polyvalent unsaturated fatty acid and/or the salt thereof can bind to components contained in the recording medium, and inhibit the dye from penetrating the deep fibers of the recording medium, enabling the dye to more readily remain on the surface of the recording medium. It is presumed that the optical density (OD value) and the saturation are improved as a result. Furthermore, it is presumed the surfactant promotes spreading of the dye along the fibers of the recording medium, and as a result, spaces between the dots are filled, improving the optical density (OD value) and the saturation. When the acidic preservative is dehydroacetic acid and/or a salt thereof, the dehydroacetic acid and/or the salt thereof and the dye are miscible in water. However, the solvent and the like soak into and evaporate on the surface of the recording medium, and thus the amount of water decreases. It is presumed that as a result, the dye agglomerates, improving the optical density (OD value) and the saturation. However, the mechanism is only a presumption, and the present disclosure is not limited thereto.

The water-based ink of the present disclosure can impart preservative properties without using industrial acidic preservatives and thus can be safely used without, for example, exerting adverse effects on the environment and the health of the human body.

The water-based ink further includes a surfactant. Examples of the surfactant include acetylene-based surfactants and the like.

For example, a commercial product may be used as the acetylene-based surfactant. Examples of the commercial products include “Olfine® E1004,” “Olfine® E1008,” and “Olfine® E1010” made by Nissin Chemical Industry Co., Ltd., “Surfynol® 440,” “Surfynol® 465,” and “Surfynol® 485” made by Air Products and Chemicals, Inc., “Acetylenol® E40” and “Acetylenol® E100” made by Kawaken Fine Chemicals Co., Ltd., and the like.

The water-based ink may contain another surfactant in addition to or instead of the acetylene-based surfactant. Examples of other surfactants include the nonionic surfactant “EMULGEN®” series, “RHEODOL®” series, “EMASOL®” series, “EXCEL®” series, “EMANON®” series, “AMIET®” series, “AMINON®” series, and the like made by Kao Corporation, the nonionic surfactant “Sorbon®” series and the like made by Toho Chemical Industry Co., Ltd., the nonionic surfactant “DOBANOX®” series, “LEOCOL®” series, “LEOX®” series, “LAOL, LEOCOL®” series, “LIONOL®” series, “CADENAX®” series, “LIONON®” series, “LEOFAT®” series, and the like made by Lion Corporation, the anionic surfactant “EMAL®” series, “LATEMUL®” series, “VENOL®” series, “NEOPELEX®” series, NS SOAP, KS SOAP, OS SOAP and “PELEX®” series, and the like made by Kao Corporation, the anionic surfactant “LIPOLAN®” series, “LIPON®” series, “SUNNOL®” series, “LIPOTAC® TE, ENAGICOL” series, “LIPAL®” series, “LOTAT®” series, and the like made by Lion Corporation, the cationic surfactant “Catiogen® ES-OW”, “Catiogen® ES-L,” and the like made by DKS Co., Ltd. One type of the surfactant may be used alone, or two or more types may be used in combination.

The formulation amount of the surfactant is, for example, 0.01 to 5% by weight, preferably 0.05 to 5% by weight, and more preferably 0.05 to 3.0% by weight. In particular, the formulation amount of the acetylene-based surfactant with respect to the total amount of water-based ink is, for example, 0.01 to 5% by weight, preferably 0.05 to 3% by weight.

The formulation amount of the acidic preservative and the surfactant relative to the total amount of the water-based ink preferably satisfies the following Condition (X1) when the acidic preservative is, for example, at least one of a polyvalent unsaturated fatty acid and a polyvalent unsaturated fatty acid salt. The following Condition (X1) preferably has a lower limit of 1 or higher from the perspective of increasing the OD value and saturation. Furthermore, the following Condition (X1) is preferably 55 or less from the perspective of ink discharging stability.

1≤A1/B≤55 Condition (X1):

A1: Formulated amount of the acidic preservative (% by weight)

B: Formulated amount of the surfactant (% by weight)

Conversely, the formulation amount of the acidic preservative and the surfactant relative to the total amount of the water-based ink preferably satisfies the following Condition (X2) when the acidic preservative is, for example, at least one of dehydroacetic acid and a dehydroacetate. The following Condition (X2) preferably has a lower limit of 1 or higher from the perspective of increasing the OD value and saturation. Furthermore, the following Condition (X2) is preferably 60 or less from the perspective of ink discharging stability.

1≤A2/B≤60 Condition (X2):

A2: Formulated amount of the acidic preservative (% by weight)

B: Formulated amount of the surfactant (% by weight)

The water-based ink further includes a penetrant for regulating the drying rate on the recording medium.

The penetrant contains at least one of an alkylene diol and a glycol ether compound. Examples of the alkylene diol include 1,2-hexanediol, 1,2-heptanediol, 1,3-propanediol, 1,2-butanediol, 1,3-butanediol, 1,4-butanediol, 2,3-butanediol, 3-methyl-1,3-butanediol, 1,2-pentanediol, 1,5-pentanediol, 1,6-hexanediol, 2-methyl-2,4-pentanediol, and 3-methyl-1,5-pentanediol. Examples of the glycol ether compounds include ethylene glycol methyl ether, ethylene glycol ethyl ether, ethylene glycol-n-propyl ether, diethylene glycol methyl ether, diethylene glycol ethyl ether, diethylene glycol-n-propyl ether, diethylene glycol-n-butyl ether, diethylene glycol-n-hexyl ether, triethylene glycol methyl ether, triethylene glycol ethyl ether, triethylene glycol-n-propyl ether, triethylene glycol-n-butyl ether, propylene glycol methyl ether, propylene glycol ethyl ether, propylene glycol-n-propyl ether, propylene glycol-n-butyl ether, dipropylene glycol methyl ether, dipropylene glycol ethyl ether, dipropylene glycol-n-propyl ether, dipropylene glycol-n-butyl ether, tripropylene glycol methyl ether, tripropylene glycol ethyl ether, tripropylene glycol-n-propyl ether, tripropylene glycol-n-butyl ether, and the like. One type of the penetrant may be used alone, or two or more types may be used in combination.

The formulation amount of the penetrant with respect to the total amount of water-based ink is, for example, 1 to 20% by weight, preferably 1 to 15% by weight, and more preferably 1 to 10% by weight. In particular the formulation amount of at least one of the alkylene diol and the glycol ether compound with respect to the total amount of water-based ink is, for example, 1 to 20% by weight, preferably 1 to 15% by weight, and more preferably 1 to 10% by weight.

The formulation amount of the acidic preservative and the penetrant relative to the total amount of the water-based ink preferably satisfies the following Condition (Y1) when the acidic preservative is, for example, at least one of a polyvalent unsaturated fatty acid and a polyvalent unsaturated fatty acid salt. The following Condition (Y1) preferably has a lower limit of 0.1 or higher from the perspective of increasing the OD value and saturation. Furthermore, the following Condition (Y1) is preferably 10 or less from the perspective of ink discharging stability.

0.1≤A1/C≤10 Condition (Y1):

A1: Formulated amount of the acidic preservative (% by weight)

C: Formulated amount of the penetrant (% by weight)

Conversely, the formulation amount of the acidic preservative and the penetrant relative to the total amount of the water-based ink preferably satisfies the following Condition (Y2) when the acidic preservative is, for example, at least one of dehydroacetic acid and a dehydroacetate. The following Condition (Y2) preferably has a lower limit of 0.02 or higher from the perspective of increasing the OD value and saturation. Furthermore, the following condition (Y2) is preferably 6 or less from the perspective of ink discharging stability.

0.02≤A2/C≤6 Condition (Y2):

A2: Formulated amount of the acidic preservative (% by weight)

C: Formulated amount of the penetrant (% by weight)

The water-based ink may further contain a wetting agent for preventing drying of the water-based ink on the nozzle tip of the inkjet head.

The wetting agent is not particularly limited, and examples include lower alcohols such as methyl alcohol, ethyl alcohol, n-propyl alcohol, isopropyl alcohol, n-butyl alcohol, sec-butyl alcohol, tert-butyl alcohol; amides such as dimethylformamide and dimethylacetamide; ketones such as acetone; keto alcohols such as diacetone alcohol; ethers such as tetrahydrofuran and dioxane; polyethers such as polyalkylene glycol; polyhydric alcohols such as alkylene glycol, glycerin, trimethylolpropane, and trimethylolethane; 2-pyrrolidone; N-methyl-2-pyrrolidone; 1,3-dimethyl-2-imidazolidinone; and the like. Examples of the polyalkylene glycol include polyethylene glycol, polypropylene glycol, and the like. Examples of the alkylene glycol include ethylene glycol, propylene glycol, butylene glycol, diethylene glycol, triethylene glycol, dipropylene glycol, tripropylene glycol, thiodiglycol, hexylene glycol, and the like. One type of these wetting agents may be used alone, or two or more types may be used in combination. Of these, polyhydric alcohols such as alkylene glycol, glycerin, and the like are preferable.

The formulation amount of the wetting agent with respect to the total amount of water-based ink is, for example, 0 to 95% by weight, preferably 5 to 80% by weight, and more preferably 5 to 50% by weight.

The water-based ink may further include conventionally known additives as necessary. Examples of the additives include pH adjusting agents, viscosity adjusting agents, surface tension adjusting agents, mildew-proofing agents, and the like. Examples of the viscosity adjusting agent include polyvinyl alcohol, cellulose, water-soluble resin, and the like.

Next, the ink cartridge of the present disclosure is characterized by including a water-based ink for inkjet recording, the water-based ink being the water-based ink for inkjet recording of the present disclosure. For example, a conventionally known body can be used as the body of the ink cartridge.

Next, the inkjet recording device and inkjet recording method of the present disclosure will be described.

The inkjet recording device of the present disclosure is an in inkjet recording device including an ink storage part and ink discharge means and which discharges ink stored in the ink storage part via the ink discharge means, wherein the water-based ink for inkjet recording of the present disclosure is stored in the ink storage part.

The inkjet recording method of the present disclosure is an inkjet recording method for recording by discharging a water-based ink onto a recording medium by an inkjet system, wherein the water-based ink for inkjet recording of the present disclosure is used as the water-based ink.

The inkjet recording method of the present disclosure can, for example, be performed by using the inkjet recording device of the present disclosure. The recording includes letter printing, image printing, printing, and the like.

The FIGURE illustrates a configuration of one example of the inkjet recording device of the present disclosure. As illustrated, this inkjet recording device 1 includes four ink cartridges 2, ink discharging means (inkjet head) 3, a head unit 4, a carriage 5, a drive unit 6, a platen roller 7, and a purge device 8 as main components.

The four ink cartridges 2 include water-based inks in the four colors of yellow, magenta, cyan and black, each including one color. At least one of the four colors of water-based inks is the water-based ink for inkjet recording of the present disclosure. The inkjet head 3 installed in the head unit 4 records on a recording medium (for example, recording paper) P. The four ink cartridges 2 and the head unit 4 are mounted on the carriage 5. The drive unit 6 drives the carriage 5 back and forth in a linear direction. For example, a conventionally known drive unit (for example, see JP 2008-246821 A. The contents of this documents are incorporated herein by reference in their entireties.) can be used as the drive unit 6. The platen roller 7 extends in the reciprocating direction of the carriage 5 and is disposed opposing the inkjet head 3.

The purge device 8 sucks up defective ink containing bubbles or the like that accumulates in the inkjet head 3. For example, a conventionally known purge device (for example, see JP 2008-246821 A.) can be used as the purge device 8.

A wiper member 20 is disposed adjacent to the purge device 8 on the platen roller 7 side of the purge device 8. The wiper member 20 is formed in a spatula shape and wipes the nozzle forming surface of the inkjet head 3 in conjunction with the movement of the carriage 5. In the FIGURE, in order to prevent drying of the water-based ink, the cap 18 covers a plurality of nozzles of the inkjet head 3 that is returned to a reset position when recording is completed.

The inkjet recording device 1 of the present example has four ink cartridges 2 mounted on one carriage 5 together with the head unit 4. However, the present disclosure is not limited thereto. Each of the four ink cartridges 2 of the inkjet recording device 1 may be installed on a separate carriage from the head unit 4. Each cartridge of the four ink cartridges 2 may be disposed and fixed within the inkjet recording device 1, rather than being mounted on the carriage 5. In these embodiments, for example, each of the four ink cartridges 2 and the head unit 4 mounted on the carriage 5 are connected by a tube or the like, and the water-based ink is supplied from each of the four ink cartridges 2 to the head unit 4.

Inkjet recording using this inkjet recording device 1 is, for example, performed as follows. First, the recording paper P is fed from a paper feeding cassette (not illustrated) provided to the side of or below of the inkjet recording device 1. The recording paper P is introduced between the inkjet head 3 and the platen roller 7. Predetermined recording is performed on the introduced recording paper P by using the water-based ink discharged from the ink jet head 3. The recording paper P is ejected from the inkjet recording device 1 after recording. The recorded matter recorded in the water-based ink of the present disclosure has a high optical density (OD value). Illustration of the paper feeding mechanism and paper ejecting mechanism of the recording paper P is omitted in the FIGURE.

The device illustrated in the FIGURE adopts a serial inkjet head, but the present disclosure is not limited thereto. The ink jet recording device may employ a line-type inkjet head.

### EXAMPLES

Next, examples of the present disclosure will be described together with comparative examples. Note, the present disclosure is not limited or restricted by the following examples and comparative examples.

### Examples 1-1 to 1-10 and Comparative Examples 1-1 to 1-5

Each component in the water-based ink composition (Tables 1 and 2) was uniformly mixed. Then, the obtained mixture was filtered using a hydrophilic polytetrafluoroethylene (PTFE) membrane filter (pore diameter 0.20 μm) made by Toyo Roshi Kaisha, Ltd. to obtain the water-based ink for inkjet recording in Examples 1-1 to 1-10 and Comparative Examples 1-1 to 1-5. Note, as shown in Table 1, Examples 1-1 to 1-10 used either potassium sorbate or sodium sorbate as the acidic preservative.

The water-based inks of Examples 1-1 to 1-10 and Comparative Examples 1-1 to 1-5 were subjected to (a) recording density evaluation, (b) saturation evaluation, and (c) preservative property evaluation according to the following methods.

(a) Recording Density Evaluation

The water-based inks of Examples 1-1 to 1-10 and Comparative Examples 1-1 to 1-5 were applied to a recording medium (“Multipaper Super White+” made by Askul Corporation) such that the application amount per unit area was approximately 0.90 mg/cm2, producing an evaluation sample. Optical densities (OD value) of five locations in the evaluation sample were measured using a SpectroEye spectrophotometer (light source: D50, viewing angle: 2°, ANSI-T) made by X-Rite, Incorporated, and the average value was obtained. Next, the optical density (OD value) difference (ΔOD) was calculated by subtracting the optical density (OD value) in Comparative Example 1-1, in which the evaluation sample was produced using only a water-based cyan ink (C.I. Direct Blue 199) without using an acidic preservative, from the optical density (OD value) in Examples 1-1 to 1-9 and Comparative Examples 1-2 to 1-4. Similarly, the optical density (OD value) difference (ΔOD) was calculated by subtracting the optical density (OD value) in Comparative Example 1-5, in which the evaluation sample was produced using only a water-based magenta ink (C.I. Acid Red 289) without using an acidic preservative, from the optical density (OD value) in Example 1-10. The recording density was evaluated according to the following evaluation criteria.

Recording Density Evaluation: Evaluation Criteria

A: Improvement of optical density (OD value) (ΔOD) was 0.03 or more.

B: Improvement of optical density (OD value) (ΔOD) was 0.01 to 0.02.

C: Improvement of optical density (OD value) (ΔOD) was 0 or less.

(b) Saturation Evaluation

The saturation (C*) of five locations in the evaluation sample in the recording density evaluation (a) was measured using the SpectroEye spectrophotometer, the average value was obtained, and the cyan and magenta saturation were evaluated according to the following evaluation criteria.

Cyan Saturation Evaluation: Evaluation Criteria

A: Saturation (C*) was 51 or more.

B: Saturation (C*) was 50 or more and less than 51.

C: Saturation (C*) was 49 or less.

Magenta Saturation Evaluation: Evaluation Criteria

A: Saturation (C*) was 72 or more.

B: Saturation (C*) was 71 or more and less than 72.

C: Saturation (C*) was 70 or less.

(c) Preservative Property Evaluation

The water-based inks of Examples 1-1 to 1-10 and Comparative Examples 1-1 to 1-5 were applied to a standard agar culture medium and stored for three days in a 35° C. temperature environment. Then, it was visually checked whether a fungal colony had developed in the standard agar culture medium, and the preservative properties were evaluated according to the following evaluation criteria.

Preservative Property Evaluation: Evaluation Criteria

A: No colonies developed

C: A colony developed

Table 1 and Table 2 show the water-based ink composition and evaluation results of the water-based inks of Examples 1-1 to 1-10 and Comparative Examples 1-1 to 1-5.

TABLE 1

| | | | Example | | | | |
|---|---|---|---|---|---|---|---|
| | | | 1-1 | 1-2 | 1-3 | 1-4 | 1-5 |
| Water- | Dye | C.I. Direct | 3.0 | 3.0 | 3.0 | 3.0 | 3.0 |
| based | | Blue 199 | | | | | |
| ink | | C.I. Acid | — | — | — | — | — |
| compo- | | Red 289 | | | | | |
| sition | Preser- | Potassium | 5.0 | 3.0 | 0.5 | — | 5.0 |
| (% by | vative | sorbate (*1) | | | | | |
| weight) | | Sodium | — | — | — | 3.0 | — |
| | | sorbate (#2) | | | | | |
| | | Proxel | — | — | — | — | — |
| | | GXL(s) (*3) | | | | | |
| | | Sodium L- | — | — | — | — | — |
| | | ascorbate (*4) | | | | | |
| | Wetting | Glycerin | 20.0 | 20.0 | 20.0 | 20.0 | 15.0 |
| | agent | Propylene | — | — | — | — | 5.0 |
| | | glycol | | | | | |
| | Pene- | Triethylene | 1.0 | 1.0 | 1.0 | — | — |
| | trant | glycol n- | | | | | |
| | | butyl ether | | | | | |
| | | 1,2- | — | — | — | 0.5 | 0.5 |
| | | Hexanediol | | | | | |
| | | 3-Methyl-1,5- | — | — | — | 3.0 | 3.0 |
| | | pentanediol | | | | | |
| | Surfac- | Olfine ® | 0.2 | 0.2 | 0.2 | 0.2 | 0.1 |
| | tant | E1010 (*5) | | | | | |
| | | Olfine ® | — | — | — | — | — |
| | | E1004 (*6) | | | | | |
| | Triethanolamine (*7) | | — | — | — | — | — |
| | Water | | Remain- | Remain- | Remain- | Remain- | Remain- |
| | | | der | der | der | der | der |
| Rati | Acidic preservative/ | | 25.0 | 15.0 | 2.5 | 15.0 | 50.0 |
| | surfactant | | | | | | |
| | Acidic preservative/ | | 5.0 | 3.0 | 0.5 | 0.9 | 1.4 |
| | penetrant | | | | | | |
| Evaluation | | Optical | A | A | B | A | A |
| | | density | (1.07) | (1.06) | (1.05) | (1.14) | (1.09) |
| | | (OD value) | | | | | |
| | | Saturation | A | A | B | A | B |
| | | (measured | (51) | (51) | (50) | (52) | (50) |
| | | value) | | | | | |
| | | Preservative | A | A | A | A | A |
| | | performance | | | | | |
| | | | Example | | | | |
| | | | 1-6 | 1-7 | 1-8 | 1-9 | 1-10 |
| Water- | Dye | C.I. Direct | 3.0 | 3.0 | 3.0 | 3.0 | — |
| based | | Blue 199 | | | | | |
| ink | | C.I. Acid | — | — | — | — | 2.5 |
| compo- | | Red 289 | | | | | |
| sition | Preser- | Potassium | 5.0 | 5.0 | 5.0 | 5.0 | 5.0 |
| (% by | vative | sorbate (*1) | | | | | |
| weight) | | Sodium | — | — | — | — | — |
| | | sorbate (#2) | | | | | |
| | | Proxel | — | — | — | — | — |
| | | GXL(s) (*3) | | | | | |
| | | Sodium L- | — | — | — | — | — |
| | | ascorbate (*4) | | | | | |
| | Wetting | Glycerin | 20.0 | 20.0 | 20.0 | 20.0 | 15.0 |
| | agent | Propylene | — | — | — | — | 5.0 |
| | | glycol | | | | | |
| | Pene- | Triethylene | — | — | — | 5.0 | 1.0 |
| | trant | glycol n- | | | | | |
| | | butyl ether | | | | | |
| | | 1,2- | 0.5 | 0.5 | — | — | — |
| | | Hexanediol | | | | | |
| | | 3-Methyl-1,5- | 3.0 | 3.0 | — | — | — |
| | | pentanediol | | | | | |
| | Surfac- | Olfine ® | — | 0.2 | 1.0 | — | 0.2 |
| | tant | E1010 (*5) | | | | | |
| | | Olfine ® | 0.2 | — | — | — | — |
| | | E1004 (*6) | | | | | |

| | | | | | | |
|---|---|---|---|---|---|---|
| | Triethanolamine (*7) | — | 0.3 | — | — | — |
| | Water | Remain- | Remain- | Remain- | Remain- | Remain- |
| | | der | der | der | der | der |
| Rati | Acidic preservative/ | 25.0 | 25.0 | 5.0 | — | 25.0 |
| | surfactant | | | | | |
| | Acidic preservative/ | 1.4 | 1.4 | — | 1.0 | 5.0 |
| | penetrant | | | | | |

| | | | | | | |
|---|---|---|---|---|---|---|
| Evaluation | Optical | A | A | A | A | A |
| | density | (1.10) | (1.11) | (1.06) | (1.07) | (1.02) |
| | (OD value) | | | | | |
| | Saturation | A | A | A | B | A |
| | (measured | (52) | (52) | (51) | (50) | (72) |
| | value) | | | | | |
| | Preservative | A | A | A | A | A |
| | performance | | | | | |

(*1): Made by Kanto Chemical Co., Ltd.
(*2): Made by Kanto Chemical Co., Ltd.
(*3): Made by Arch Chemicals, Inc.
(*4): Made by Kanto Chemical Co., Ltd.
(*5): Acetylene glycol-based surfactant (ethylene oxide (10 mol) adduct of diol): Nissin Chemical Industry Co., Ltd.; active ingredient = 100%
(*6): Acetylene glycol-based surfactant (ethylene oxide (4 mol) adduct of diol): Nissin Chemical Industry Co., Ltd.; active ingredient = 100%
(*7): Made by Kanto Chemical Co., Ltd.

TABLE 2

| | | | Comparative Example | | | | |
|---|---|---|---|---|---|---|---|
| | | | 1-1 | 1-2 | 1-3 | 1-4 | 1-5 |
| Water- | Dye | C.I. Direct | 3.0 | 3.0 | 3.0 | 3.0 | — |
| based | | Blue 199 | | | | | |
| ink | | C.I. Acid | — | — | — | — | 2.5 |
| compo- | | Red 289 | | | | | |
| sition | Preser- | Potassium | — | 5.0 | — | — | — |
| (% by | vative | sorbate (*1) | | | | | |
| weight) | | Sodium | — | — | — | — | — |
| | | sorbate (#2) | | | | | |
| | | Proxel | — | — | 0.2 | — | — |
| | | GXL(s) (*3) | | | | | |
| | | Sodium L- | — | — | — | 5.0 | — |
| | | ascorbate (*4) | | | | | |
| | Wetting | Glycerin | 20.0 | 20.0 | 20.0 | 20.0 | 15.0 |
| | agent | Propylene | — | — | — | — | 5.0 |
| | | glycol | | | | | |
| | Pene- | Triethylene | 1.0 | — | 1.0 | 1.0 | 1.0 |
| | trant | glycol n- | | | | | |
| | | butyl ether | | | | | |
| | | 1,2- | — | — | — | — | — |
| | | Hexanediol | | | | | |
| | | 3-Methyl-1,5- | — | — | — | — | — |
| | | pentanediol | | | | | |
| | Surfac- | Olfine ® | 0.2 | — | 0.2 | 0.2 | 0.2 |
| | tant | E1010 (*5) | | | | | |
| | | Olfine ® | — | — | — | — | — |
| | | E1004 (*6) | | | | | |

| | | | | | |
|---|---|---|---|---|---|
| Triethanolamine (*7) | — | — | — | — | — |
| Water | Remain- | Remain- | Remain- | Remain- | Remain- |
| | der | der | der | der | der |
| Sorbate/surfactant | — | — | — | — | — |
| Sorbate/penetrant | — | — | — | — | — |

| | | | | | | |
|---|---|---|---|---|---|---|
| Evaluation | Optical | — | B | C | A | — |
| | density | (1.03) | (1.04) | (1.03) | (1.09) | (0.97) |
| | (OD value) | | | | | |
| | Saturation | C | C | B | C | C |
| | (measured | (49) | (49) | (50) | (47) | (70) |
| | value) | | | | | |
| | Preservative | C | A | A | C | C |
| | performance | | | | | |

(*1): Made by Kanto Chemical Co., Ltd.
(*2): Made by Kanto Chemical Co., Ltd.
(*3): Made by Arch Chemicals, Inc.
(*4): Made by Kanto Chemical Co., Ltd.
(*5): Acetylene glycol-based surfactant (ethylene oxide (10 mol) adduct of diol): Nissin Chemical Industry Co., Ltd.; active ingredient = 100%
(*6): Acetylene glycol-based surfactant (ethylene oxide (4 mol) adduct of diol): Nissin Chemical Industry Co., Ltd.; active ingredient = 100%
(*7): Made by Kanto Chemical Co., Ltd.

As shown in Table 1, the results of the recording density evaluation, saturation evaluation, and preservative property evaluation were all satisfactory in Examples 1-1 to 1-10.

Conversely, as shown in Table 2, the results of the saturation evaluation and preservative property evaluation were poor for Comparative Examples 1-1 and 1-5, which did not use the acidic preservative. Also, the saturation evaluation was poor for Comparative Example 1-2, which used neither the surfactant nor the penetrant. Furthermore, in Comparative Example 1-3, which used 1,2-dibenzinthiazolin-3-one (product name: PROXEL GXL from LONZA) instead of the acidic preservative, the results of the recording evaluation were poor. Moreover, the results of the saturation evaluation and preservative property evaluation were poor in Comparative Example 1-4, which used sodium ascorbate instead of the acidic preservative.

### Examples 2-1 to 2-14 and Comparative Examples 2-1 to 2-6

Each component in the water-based ink composition (Tables 3 and 4) was uniformly mixed. Then, the obtained mixture was filtered using a hydrophilic polytetrafluoroethylene (PTFE) membrane filter (pore diameter 0.20 μm) made by Toyo Roshi Kaisha, Ltd. to obtain the water-based ink for inkjet recording in Examples 2-1 to 2-14 and Comparative Examples 2-1 to 2-6. Note, as shown in Table 3, Examples 2-1 to 2-14 used sodium dehydroacetate as the acidic preservative.

Other than performing the (a) recording density evaluation as follows, the water-based inks of Examples 2-1 to 2-14 and Comparative Examples 2-1 to 2-6 were subjected to (b) saturation evaluation, and (c) preservative property evaluation in the same manner as Examples 1-1 to 1-10 and Comparative Examples 1-1 to 1-5.

(a) Recording Density Evaluation

The water-based inks of Examples 2-1 to 2-14 and Comparative Examples 2-1 to 2-6 were applied to a recording medium (“Multipaper Super White+” made by Askul Corporation) such that the application amount per unit area was approximately 0.90 mg/cm2, producing an evaluation sample. Optical densities (OD value) of five locations in the evaluation sample were measured using a SpectroEye spectrophotometer (light source: D50, viewing angle: 2°, ANSI-T) made by X-Rite, Incorporated, and the average value was obtained. Next, the optical density (OD value) difference (ΔOD) was calculated by subtracting the optical density (OD value) in Comparative Example 2-1, in which the evaluation sample was produced using only a water-based cyan ink (C.I. Direct Blue 199) without using an acidic preservative, from the optical density (OD value) in Examples 2-1 to 2-13 and Comparative Examples 2-2 to 2-5. Similarly, the optical density (OD value) difference (ΔOD) was calculated by subtracting the optical density (OD value) in Comparative Example 2-6, in which the evaluation sample was produced using only a water-based magenta ink (C.I. Acid Red 289) without using an acidic preservative, from the optical density (OD value) in Example 2-14. The recording density was evaluated according to the following evaluation criteria.

Recording Density Evaluation: Evaluation Criteria

A: Improvement of optical density (OD value) (ΔOD) was 0.03 or more.

B: Improvement of optical density (OD value) (ΔOD) was 0.01 to 0.02.

C: Improvement of optical density (OD value) (ΔOD) was 0 or less.

Table 3 and Table 4 show the ink composition and evaluation results of the water-based inks of Examples 2-1 to 2-14 and Comparative Examples 2-1 to 2-6.

TABLE 3

| | | | Example | | | | | | |
|---|---|---|---|---|---|---|---|---|---|
| | | | 2-1 | 2-2 | 2-3 | 2-4 | 2-5 | 2-6 | 2-7 |
| Water- | Dye | C.I. Direct | 3.0 | 3.0 | 3.0 | 3.0 | 3.0 | 3.0 | 3.0 |
| based | | Blue 199 | | | | | | | |
| ink | | C.I. Acid | — | — | — | — | — | — | — |
| compo- | | Red 289 | | | | | | | |
| sition | Preser- | Sodium | 5.0 | 3.0 | 1.0 | 0.5 | 1.0 | 1.0 | 1.0 |
| (% by | vative | dehydroacetate (*8) | | | | | | | |
| weight) | | Proxel | — | — | — | — | — | — | — |
| | | GXL(s) (*3) | | | | | | | |
| | | Kojic | — | — | — | — | — | — | — |
| | | acid (*9) | | | | | | | |
| | | Sodium L- | — | — | — | — | — | — | — |
| | | ascorbate (*4) | | | | | | | |
| | Wetting | Glycerin | 20.0 | 20.0 | 20.0 | 20.0 | 20.0 | 20.0 | 20.0 |
| | agent | Propylene | — | — | — | — | — | — | — |
| | | glycol | | | | | | | |
| | Pene- | Triethylene | 1.0 | 1.0 | 1.0 | 1.0 | 1.0 | 1.0 | — |
| | trant | glycol n- | | | | | | | |
| | | butyl ether | | | | | | | |
| | | 1,2- | — | — | — | — | — | — | 1.0 |
| | | Hexanediol | | | | | | | |
| | | 3-Methyl-1,5- | — | — | — | — | — | — | — |
| | | pentanediol | | | | | | | |
| | Surfac- | Olfine ® | 0.2 | 0.2 | 0.2 | 0.2 | 0.1 | — | 0.2 |
| | tant | E1010 (*5) | | | | | | | |
| | | Olfine ® | — | — | — | — | — | 0.2 | — |
| | | E1004 (*6) | | | | | | | |
| | Water | | Remain- | Remain- | Remain- | Remain- | Remain- | Remain- | Remain- |
| | | | der | der | der | der | der | der | der |
| Ratio | Dehydroacetate/ | | 25.0 | 15.0 | 5.0 | 3.0 | 10.0 | 5.0 | 5.0 |
| | surfactant | | | | | | | | |
| | Dehydroacetate/ | | 5.0 | 3.0 | 1.0 | 1.0 | 1.0 | 1.0 | 1.0 |
| | penetrant | | | | | | | | |
| Evaluation | | Optical | A | A | A | B | B | B | A |
| | | density | (1.12) | (1.09) | (1.06) | (1.05) | (1.05) | (1.05) | (1.07) |
| | | (OD value) | | | | | | | |
| | | Saturation | A | A | A | B | B | A | A |
| | | (measured | (53) | (52) | (51) | (50) | (50) | (51) | (52) |
| | | value) | | | | | | | |
| | | Preservative | A | A | A | A | A | A | A |
| | | performance | | | | | | | |
| | | | Example | | | | | | |
| | | | 2-8 | 2-9 | 2-10 | 2-11 | 2-12 | 2-13 | 2-14 |
| Water- | Dye | C.I. Direct | 3.0 | 3.0 | 3.0 | 3.0 | 3.0 | 3.0 | — |
| based | | Blue 199 | | | | | | | |
| ink | | C.I. Acid | — | — | — | — | — | — | 2.5 |
| compo- | | Red 289 | | | | | | | |
| sition | Preser- | Sodium | 1.0 | 1.0 | 1.0 | 1.0 | 1.0 | 1.0 | 1.0 |
| (% by | vative | dehydroacetate (*8) | | | | | | | |
| weight) | | Proxel | — | — | — | — | — | — | — |
| | | GXL(s) (*3) | | | | | | | |
| | | Kojic | — | — | — | — | — | — | — |
| | | acid (*9) | | | | | | | |
| | | Sodium L- | — | — | — | — | — | — | — |
| | | ascorbate (*4) | | | | | | | |
| | Wetting | Glycerin | 20.0 | 20.0 | 20.0 | 20.0 | 20.0 | 20.0 | 15.0 |
| | agent | Propylene | — | — | — | — | — | — | 5.0 |
| | | glycol | | | | | | | |
| | Pene- | Triethylene | — | — | — | 0.5 | 11.0 | 3.0 | 1.0 |
| | trant | glycol n- | | | | | | | |
| | | butyl ether | | | | | | | |
| | | 1,2- | 0.5 | — | — | — | — | — | — |
| | | Hexanediol | | | | | | | |
| | | 3-Methyl-1,5- | 3.0 | 5.0 | — | — | — | — | — |
| | | pentanediol | | | | | | | |
| | Surfac- | Olfine ® | 0.2 | 0.2 | 1.0 | 0.2 | 0.2 | — | 0.2 |
| | tant | E1010 (*5) | | | | | | | |
| | | Olfine ® | — | — | — | — | — | — | — |
| | | E1004 (*6) | | | | | | | |

| | | | | | | | | |
|---|---|---|---|---|---|---|---|---|
| | Water | Remain- | Remain- | Remain- | Remain- | Remain- | Remain- | Remain- |
| | | der | der | der | der | der | der | der |
| Ratio | Dehydroacetate/ | 5.0 | 5.0 | 1.0 | 5.0 | 5.0 | — | 5.0 |
| | surfactant | | | | | | | |
| | Dehydroacetate/ | 0.3 | 0.2 | — | 2.0 | 0.1 | 0.3 | 1.0 |
| | penetrant | | | | | | | |

| | | | | | | | | |
|---|---|---|---|---|---|---|---|---|
| Evaluation | Optical | A | B | A | B | B | A | A |
| | density | (1.06) | (1.05) | (1.06) | (1.05) | (1.04) | (1.06) | (1.01) |
| | (OD value) | | | | | | | |
| | Saturation | A | A | A | B | B | A | A |
| | (measured | (51) | (51) | (51) | (50) | (50) | (51) | (73) |
| | value) | | | | | | | |
| | Preservative | A | A | A | A | A | A | A |
| | performance | | | | | | | |

(*8): Made by Kanto Chemical Co., Ltd.
(*3): Made by Arch Chemicals, Inc.
(*9): Made by Tokyo Chemical Industry Co., Ltd.
(*4): Made by Kanto Chemical Co., Ltd.
(*5): Acetylene glycol-based surfactant (ethylene oxide (10 mol) adduct of diol): Nissin Chemical Industry Co., Ltd.; active ingredient = 100%
(*6): Acetylene glycol-based surfactant (ethylene oxide (4 mol) adduct of diol): Nissin Chemical Industry Co., Ltd.; active ingredient = 100%

TABLE 4

| | | | Comparative Example | | | | | |
|---|---|---|---|---|---|---|---|---|
| | | | 2-1 | 2-2 | 2-3 | 2-4 | 2-5 | 2-6 |
| Water- | Dye | C.I. Direct | 3.0 | 3.0 | 3.0 | 3.0 | 3.0 | — |
| based | | Blue 199 | | | | | | |
| ink | | C.I. Acid | — | — | — | — | — | 2.5 |
| compo- | | Red 289 | | | | | | |
| sition | Preser- | Sodium | — | 1.0 | — | — | — | — |
| (% by | vative | dehydroacetate (*8) | | | | | | |
| weight) | | Proxel | — | — | 0.2 | — | — | — |
| | | GXL(s) (*3) | | | | | | |
| | | Kojic | — | — | — | — | 5.0 | — |
| | | acid (*9) | | | | | | |
| | | Sodium L- | — | — | — | 5.0 | — | — |
| | | ascorbate (*4) | | | | | | |
| | Wetting | Glycerin | 20.0 | 20.0 | 20.0 | 20.0 | 20.0 | 15.0 |
| | agent | Propylene | — | — | — | — | — | 5.0 |
| | | glycol | | | | | | |
| | Pene- | Triethylene | 1.0 | — | 1.0 | 1.0 | 1.0 | 1.0 |
| | trant | glycol n- | | | | | | |
| | | butyl ether | | | | | | |
| | | 1,2- | — | — | — | — | — | — |
| | | Hexanediol | | | | | | |
| | | 3-Methyl-1,5- | — | — | — | — | — | — |
| | | pentanediol | | | | | | |
| | Surfac- | Olfine ® | 0.2 | — | 0.2 | 0.2 | 0.2 | 0.2 |
| | tant | E1010 (*5) | | | | | | |
| | | Olfine ® | — | — | — | — | — | — |
| | | E1004 (*6) | | | | | | |

| | | | | | | | |
|---|---|---|---|---|---|---|---|
| | Water | Remain- | Remain- | Remain- | Remain- | Remain- | Remain- |
| | | der | der | der | der | der | der |
| Ratio | Dehydroacetate/ | — | — | — | — | — | — |
| | surfactant | | | | | | |
| | Dehydroacetate/ | — | — | — | — | — | — |
| | penetrant | | | | | | |

| | | | | | | | |
|---|---|---|---|---|---|---|---|
| Evaluation | Optical | — | B | C | A | C | — |
| | density | (1.03) | (1.04) | (1.03) | (1.09) | (1.02) | (0.97) |
| | (OD value) | | | | | | |
| | Saturation | C | C | B | C | C | C |
| | (measured | (49) | (49) | (50) | (47) | (46) | (70) |
| | value) | | | | | | |
| | Preservative | C | A | A | C | C | C |
| | performance | | | | | | |

(*8): Made by Kanto Chemical Co., Ltd.
(*3): Made by Arch Chemicals, Inc.
(*9): Made by Tokyo Chemical Industry Co., Ltd.
(*4): Made by Kanto Chemical Co., Ltd.
(*5): Acetylene glycol-based surfactant (ethylene oxide (10 mol) adduct of diol): Nissin Chemical Industry Co., Ltd.; active ingredient = 100%
(*6): Acetylene glycol-based surfactant (ethylene oxide (4 mol) adduct of diol): Nissin Chemical Industry Co., Ltd.; active ingredient = 100%

As shown in Table 3, and the results of the recording density evaluation and preservative property evaluation were all satisfactory in Examples 2-1 to 2-14.

Conversely, as shown in Table 4, the results of the saturation evaluation and preservative property evaluation were poor for Comparative Examples 2-1 and 2-6, which did not use the acidic preservative. Also, the saturation evaluation was poor for Comparative Example 2-2, which used neither the surfactant nor the penetrant. Furthermore, in Comparative Example 2-3, which used 1,2-dibenzinthiazolin-3-one (product name: PROXEL GXL from LONZA) instead of the acidic preservative, the results of the recording evaluation were poor. Moreover, the results of the saturation evaluation and preservative property evaluation were poor in Comparative Example 2-4, which used sodium ascorbate instead of the acidic preservative. Moreover, the results of the recording density evaluation, saturation evaluation, and preservative property evaluation were poor in Comparative Example 2-5, which used kojic acid instead of the acidic preservative.

As described above, the water-based ink of the present disclosure can improve the optical density (OD value) and saturation of a recorded matter made using a water-based ink without increasing the coloring agent density and can impart preservative properties. The applications of the water-based ink of the present disclosure are not particularly limited, and it can be widely applied to various types of inkjet recording.

Obviously, numerous modifications and variations of the present invention(s) are possible in light of the above teachings. It is therefore to be understood that within the scope of the appended claims, the invention(s) may be practiced otherwise than as specifically described herein.

What is claimed is:

1. A water-based ink comprising: a dye; water; an acidic preservative; and at least one of a surfactant and a penetrant.

2. The water-based ink according to claim 1, wherein the acidic preservative comprises at least one selected from the group consisting of a polyvalent unsaturated fatty acid, a polyvalent unsaturated fatty acid salt, dehydroacetic acid, and a dehydroacetate.

3. The water-based ink according to claim 2, wherein the polyvalent unsaturated fatty acid is sorbic acid, and the polyvalent unsaturated fatty acid salt is a sorbate.

4. The water-based ink according to claim 3, wherein the sorbate comprises at least one selected from the group consisting of potassium sorbate and sodium sorbate.

5. The water-based ink according to claim 2, wherein the dehydroacetate is sodium dehydroacetate.

6. The water-based ink according to claim 1, wherein a content of the acidic preservative in the water-based ink is 0.3% by mass to 6.0% by mass relative to a total mass of the water-based ink.

7. The water-based ink according to claim 1, wherein the acidic preservative comprises at least one selected from the group consisting of dehydroacetic acid and a dehydroacetate, and a total content of dehydroacetic acid and the dehydroacetate in the water-based ink is 1.0% by mass to 5.0% by mass relative to a total mass of the water-based ink.

8. The water-based ink according to claim 1, wherein the surfactant comprises an acetylene-based surfactant.

9. The water-based ink according to claim 1, wherein a content of the surfactant in the water-based ink is 0.05% by mass to 3.0% by mass relative to a total mass of the water-based ink.

10. The water-based ink according to claim 1, wherein the penetrant comprises at least one selected from the group consisting of an alkylene diol and a glycol ether compound.

11. The water-based ink according to claim 1, wherein an amount of the penetrant in the water-based ink is 1.0% by mass to 10.0% by mass relative to a total mass of the water-based ink.

12. The water-based ink according to claim 1, wherein the penetrant comprises at least one selected from the group consisting of 1,2-hexanediol, 3-methyl-1,5-pentanediol, and triethylene glycol-n-butyl ether (BTG).

13. The water-based ink according to claim 2, wherein,
when the acidic preservative comprises at least one selected from the group consisting of a polyvalent unsaturated fatty acid and a polyvalent unsaturated fatty acid salt, an amount of the acidic preservative and an amount of the surfactant satisfy (X1), and
when the acidic preservative comprises at least one selected from the group consisting of dehydroacetic acid and a dehydroacetate, an amount of the acidic preservative and an amount of the surfactant satisfy Condition (X2):
1≤A1/B≤55, Condition (X1):
1≤A2/B≤60, Condition (X2):
wherein A1 is the amount of the acidic preservative (% by weight), A2 is the amount of the acidic preservative (% by weight), and B is the amount of the surfactant (% by weight).

14. The water-based ink according to claim 2, wherein,
when the acidic preservative comprises at least one selected from the group consisting of a polyvalent unsaturated fatty acid and a polyvalent unsaturated fatty acid salt, an amount of the acidic preservative and an amount of the penetrant satisfy Condition (Y1), and
when the acidic preservative comprises at least one selected from the group consisting of dehydroacetic acid and a dehydroacetate, an amount of the acidic preservative and an amount of the penetrant satisfy the following Condition (Y2):
0.1≤A1/C≤10, Condition (Y1):
0.02≤A2/C≤6, Condition (Y2):
wherein A1 is the amount of the acidic preservative (% by weight), A2 is the amount of the acidic preservative (% by weight), and C is the amount of the penetrant (% by weight).

15. The water-based ink according to claim 1, wherein the surfactant comprises an acetylene-based surfactant, the penetrant comprises at least one selected from the group consisting of 1,2-hexanediol, 3-methyl-1,5-pentanediol, and triethylene glycol-n-butyl ether (BTG), and the acidic preservative comprises at least one selected from the group consisting of a polyvalent unsaturated fatty acid, a polyvalent unsaturated fatty acid salt, dehydroacetic acid, and a dehydroacetate.

16. The water-based ink according to claim 15, wherein the polyvalent unsaturated fatty acid is sorbic acid, and the polyvalent unsaturated fatty acid salt is a sorbate.

17. The water-based ink according to claim 1, wherein the water-based ink is suitable for inkjet recording.

18. A printed recording medium comprising:
a recording medium; and
the water-based ink according to claim 1, printed on the recording medium.

19. An ink cartridge comprising the water-based ink according to claim 1 stored therein.
